(19) United States
(12) Patent Application Publication
(10) Pub. No.: US 2025/0320972 A1
(43) Pub. Date: Oct. 16, 2025

(54) COMPRESSOR SYSTEM FOR EVACUATING UTILITY PIPE

(71) Applicant: ULC Technologies LLC, Hauppauge, NY (US)

(72) Inventor: Dennis John Semet, New Hyde Park, NY (US)

(21) Appl. No.: 19/175,645

(22) Filed: Apr. 10, 2025

Related U.S. Application Data
(60) Provisional application No. 63/632,915, filed on Apr. 11, 2024.

(51) Int. Cl. F17D 3/10; F04B 35/00; F04B 41/02

(52) U.S. Cl. CPC F17D 3/10; F04B 35/002; F04B 41/02

(57) ABSTRACT

The present disclosure relates to a system and method of a compressor in fluid communication with the system inlet to receive a first fluid from the gas utility pipe. The compressor system and method further including a first fuel bottle in fluid communication with the compressor to receive the first fluid from the compressor, a second fuel bottle adapted to receive a second fluid that is different than the first fluid, and a dual-fuel engine coupled with the compressor to provide input power to the compressor, the dual-fuel engine coupled with the first fuel bottle and the second fuel bottle. The dual-fuel engine is adapted to operate using the first fluid in a first operational mode and the second fluid in a second operational mode.

### CROSS-REFERENCE TO RELATED APPLICATIONS

This application claims priority to U.S. Provisional Patent Application Ser. No. 63/632,915, filed on Apr. 11, 2024, entitled “Compressor Systems and Methods of Use,” the entire disclosure of which is incorporated herein by reference.

### FIELD OF DISCLOSURE

The present disclosure relates generally to systems for removing natural gas from pipes and more specifically, to systems for utilizing a compressor to evacuate natural gas pipelines.

### BACKGROUND

During routine gas utility maintenance and construction, natural gas is often released from uncapped sections of pipes or stranded in isolated sections of pipes. Because natural gas is dosed with chemicals with a strong, unpleasant smell, consumer complaints arise during the gas utility construction and maintenance activities. Further, if enough natural gas remains trapped in the pipes, there is a risk that the natural gas could ignite, leaving the utility workers at risk of burns or other injuries. Moreover, natural gas is a potent greenhouse gas, and companies desire to take steps to prevent the natural gas from escaping into the atmosphere to support emissions goals.

Typically, compressors have been utilized to evacuate the natural gas from pipes during maintenance and construction activities. Unfortunately, while the compressors help solve many of the issues described above, the compressors present other issues when used to evacuate pipes. First, such compressors typically only run off of one type of fuel, which can leave the compressors unable to function once the fuel is depleted. Second, the compressors are typically large and not easily portable, making it difficult to transport the compressor from place to place. Third, the natural gas evacuated from the pipes is often either vented to the ambient environment or burned off, thereby producing an unpleasant smell and greenhouse gas emissions. Compressors capable of storing the evacuated natural gas and injecting it back into the pipe after maintenance typically inject the natural gas at high temperatures, which can melt plastic pipes (e.g., polyethylene) that are typically used to supply natural gas to homes and small businesses. Lastly, typical compressor systems do not include analytic systems that measure the effectiveness of the compressors at reducing greenhouse gas emissions.

### SUMMARY

In one aspect of the present disclosure, a compressor system is provided in the form of a compressor in fluid communication with a system inlet designed to couple with a utility pipe. The compressor is designed to receive a first fluid from the utility pipe. A first fuel bottle is in fluid communication with the compressor and designed to receive the first fluid from the compressor. The system also includes a second fuel bottle adapted to receive a second fluid, which is different than the first fluid. The system also includes a dual-fuel engine coupled with the compressor to provide input power to the compressor. The dual-fuel engine is coupled with the first fuel bottle and the second fuel bottle. The dual-fuel engine is adapted to operate using the first fluid in a first operational mode and the second fluid in a second operational mode

In some forms, the first fluid is provided in a form of natural gas and the second fluid is provided in the form of propane. In some examples, the system further includes a controller in electrical communication with the dual-fuel engine. The controller may be adapted to select the operational mode of the dual-fuel engine based on an availability of the first fluid and the second fluid. In some aspects, the compressor is provided in the form of a single-stage, belt-driven compressor operably coupled to the dual-fuel engine. In some forms, the system includes an aftercooler in fluid communication with the compressor, the aftercooler adapted to lower the temperature of the first fluid before the first fluid is received in the first fuel bottle. In some examples, the system includes a display unit in electrical communication with a controller. The display unit may be adapted to provide real-time data on a volume of natural gas evacuated and injected. The display unit may generate reports on greenhouse gas emissions savings based on the real-time data. In some forms, the system inlet is adapted to couple with a first utility pipe and the system outlet is adapted to couple with a second utility pipe, the compressor system adapted to evacuate the first fluid from the first utility pipe and inject the first fluid into the second utility pipe.

In another aspect, a compressor system is provided that includes a suction bottle, a compressor, a controller, and a sensor. The suction bottle is adapted to receive a fluid from a first utility pipe, and the compressor is in fluid communication with the suction bottle to receive the fluid from the suction bottle. The compressor may be designed to inject the fluid into a second utility pipe. The controller may be in electrical communication with the sensor to monitor the volume of fluid received from the first utility pipe and/or injected into the second utility pipe. The sensor can provide an input to the controller related to the volume of fluid received and/or injected, and the controller can generate an output based on the input received from the sensor.

In some embodiments, the output comprises a report containing a volume of prevented greenhouse gas emissions. In some examples, the volume of prevented greenhouse gas emissions is calculated based on the volume of fluid received and/or injected. In other embodiments, the first and second utility pipes are segments of a unitary pipe. In some aspects, the controller is in electrical communication with the dual-fuel engine. The controller may be adapted to select an operational mode of the dual-fuel engine based on an availability of the first fluid and the second fluid. In some examples, the compressor is a single-stage, belt-driven compressor operably coupled to the dual-fuel engine. In some embodiments, the system includes an aftercooler in fluid communication with the compressor, the aftercooler adapted to lower the temperature of the first fluid before the first fluid is received in a first fuel bottle. In some examples, the system includes a suction bottle pressure regulator positioned on the system inlet to regulate the pressure of the fluid entering the suction bottle. In some aspects, the system inlet is adapted to couple with a first utility pipe and the system outlet is adapted to couple with a second utility pipe. The compressor system adapted to evacuate the first fluid from the first utility pipe and inject the first fluid into the second utility pipe.

In another aspect, a compressor system is provided with a system inlet, a compressor, a first fuel bottle, a second fuel bottle, a dual-fuel engine, and an aftercooler. The system inlet is adapted to couple with a utility pipe. The compressor is in fluid communication with the system inlet to receive a first fluid from the utility pipe. The first fuel bottle is in fluid communication with the compressor to receive the first fluid from the compressor. The second fuel bottle is adapted to receive a second fluid that is different than the first fluid. The dual-fuel engine is coupled with the compressor to provide input power to the compressor. The dual-fuel engine is also coupled with the first fuel bottle and the second fuel bottle. The aftercooler is in fluid communication with the compressor and is adapted to lower a temperature of the first fluid before the first fluid is received in the first bottle.

In some aspects, the dual-fuel engine is adapted to operate using the first fluid in a first operational mode and the second fluid in a second operational mode. In some embodiments, the system includes a controller in electrical communication with the dual-fuel engine. The controller may be adapted to automatically select the operational mode of the dual-fuel engine based on an availability of the first fluid and the second fluid. In some forms, the system includes a suction bottle designed to receive the first fluid from a first segment of utility pip. The compressor is in fluid communication with the suction bottle. The compressor is designed to receive the first fluid from the suction bottle. The aftercooler is in fluid communication with the compressor and designed to reduce the temperature of the fluid before the compressor injects the first fluid into a second segment of the utility pipe. In some aspects, the system includes a controller in electrical communication with a sensor. The sensor may be designed to monitor a volume of the first fluid received from the first segment of the utility pipe and injected into the second segment of the utility pipe and to send an input to the controller related to the volume. The controller may generate an output based on the input received from the sensor. In some examples, the system includes a display unit in electrical communication with the controller. The display unit is adapted to provide real-time data on a volume of the first fluid received from the first segment of the utility pipe and injected into the second segment of the utility pipe. The display unit may generate reports on greenhouse gas emissions savings based on the real-time data.

These and other aspects and advantages of the present disclosure will become apparent to those skilled in the art after considering the following detailed description in connection with the accompanying drawings.

### BRIEF DESCRIPTION OF DRAWINGS

FIG. 1 is an isometric view of a compressor system;

FIG. 2 is an isometric view of the compressor system of FIG. 1 with an engine housing and a belt housing removed for clarity;

FIG. 3 is a top plan view of the compressor system of FIGS. 1 and 2;

FIG. 4 is a rear elevation view of the compressor system of FIGS. 1-3;

FIG. 5 is a schematic diagram of the compressor system of FIGS. 1-4;

FIG. 6 is a front isometric view of an aftercooler of the compressor system of FIGS. 1-5;

FIG. 7 is a rear elevation view of the aftercooler of FIG. 6;

FIG. 8 is an enlarged isometric view of the compressor system of FIGS. 1-7; and

FIG. 9 is a schematic diagram of a greenhouse gas emissions savings display unit of the compressor system of FIGS. 1-8.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION

Before any embodiments are described in detail, it is to be understood that the disclosure is not limited in its application to the details of construction and the arrangement of components set forth in the following description or illustrated in the following drawings, which is limited only by the claims that follow the present disclosure. The disclosure is capable of other embodiments, and of being practiced, or of being carried out, in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following description is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown but are to be accorded the widest scope consistent with the principles and features disclosed herein. The following detailed description is to be read with reference to the figures, in which like elements in different figures have like reference numerals. Skilled artisans will recognize the examples provided herein have many useful alternatives and fall within the scope of embodiments of the disclosure.

Additionally, while the following discussion may describe features associated with specific devices or embodiments, it is understood that additional devices and/or features can be used with the described systems and methods, and that the discussed devices and features are used to provide examples of possible embodiments, without being limited. It is also to be understood that “natural gas” as used herein may include any gaseous fluid comprising combustible hydrocarbons (e.g., methane, ethane, or butane). In some embodiments, natural gas may further comprise a mixture of additives (e.g., odorizers to create a distinctive odor), gases naturally present with the hydrocarbons (e.g., carbon dioxide, hydrogen sulfide, and helium), and/or other substances.

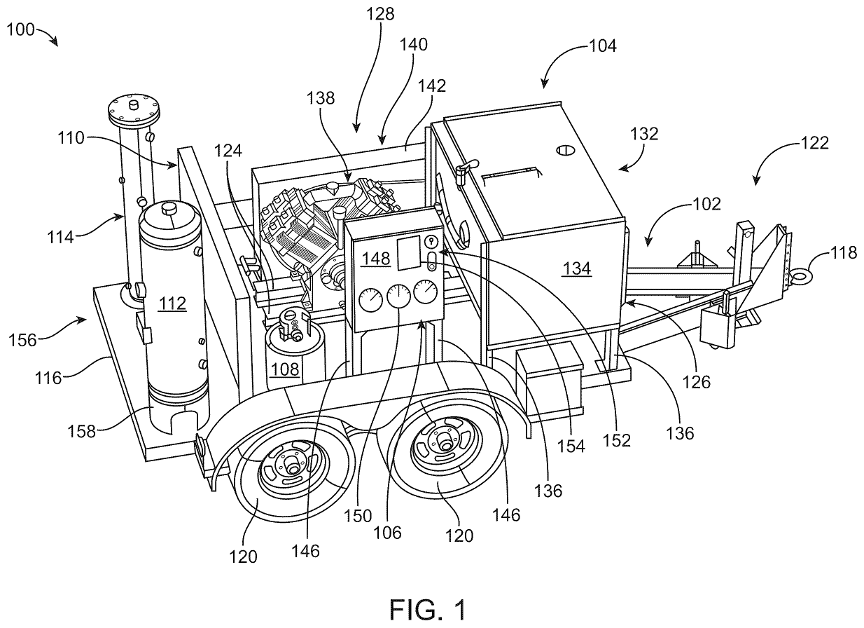

Referring to FIG. 1, a compressor system 100 is provided in the form of a portable trailer 102, a dual-fuel compressor assembly 104, a system control panel 106, a propane tank 108, an aftercooler 110, a suction bottle 112, and a fuel bottle 114. The trailer 102 may be provided in the form of a platform 116. The platform 116 may be provided in the form of a substantially flat, three-dimensional structure (e.g., a rectangular prism) that is coupled to a trailer hitch 118 extending outwardly and away from the platform 116. The platform 116 may also include tires or wheels 120, which provide support to the platform 116 and enhance the mobility of the compressor system 100. Because the components of the compressor system 100 are positioned on the trailer 102, the compressor system 100 may be towed behind a vehicle (e.g., a truck) coupled to the trailer 102 via the trailer hitch 118. In alternative embodiments, the compressor system 100 may be provided in the form of a skid-mounted system or a pallet-mounted system as opposed to a trailer-mounted system. In yet other embodiments, the compressor system 100 may be self-propelled.

The dual-fuel compressor assembly 104 may be disposed proximate to a front portion 122 (i.e., proximate to the trailer hitch 118) of the trailer 102 and provided in the form of one or more equipment rails 124, a dual-fuel engine subassembly 126, and a compressor subassembly 128. The one or more equipment rails 124 are designed to support the dual-fuel engine subassembly 126 and the compressor subassembly 128 on the trailer 102. In some aspects, the one or more equipment rails 124 may be provided in the form of I-beams.

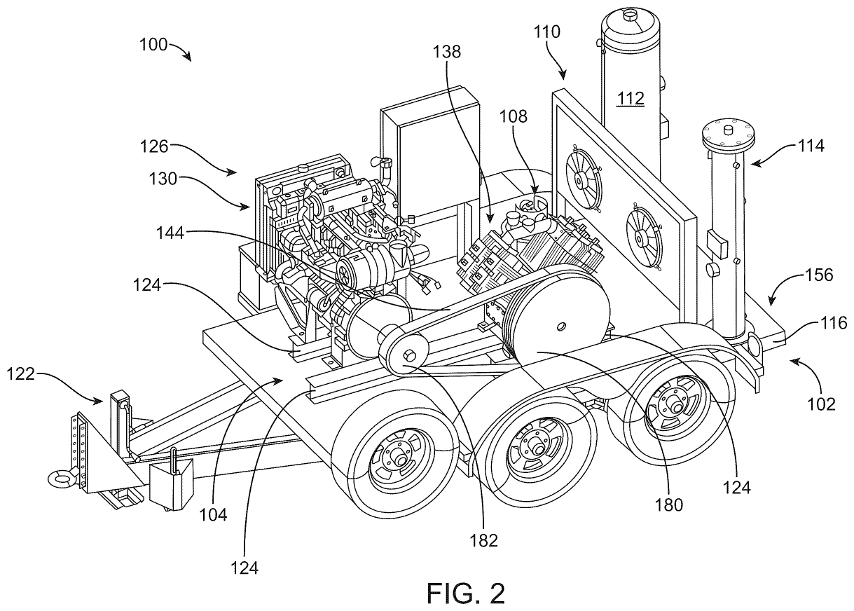

The dual-fuel engine subassembly 126 is defined by an engine module 130 (see FIG. 2) and an engine cabinet 132. The engine cabinet 132 may be provided in the form of an engine housing 134 including one or more housing legs 136. The engine housing 134 may be a three-dimensional, substantially hollow body (e.g., a rectangular prism) supported on the platform 116 by the one or more housing legs 136. As described in greater detail in connection with FIG. 2, the engine module 130 may be an internal combustion engine designed to accept a plurality of fuel sources. The engine cabinet 132 is adapted to surround the engine module 130 to substantially shield the engine module 130 from the ambient environment and/or to help reduce engine noise perceived by people near the compressor system 100.

Referring still to FIG. 1, the compressor subassembly 128 may be positioned adjacent to the dual-fuel engine subassembly 126 and is adapted to operatively engage with the dual-fuel engine subassembly 126 to compress gaseous fluids (e.g., natural gas). The compressor subassembly 128 may be provided in the form of a compressor module 138 and a belt module 140. The compressor module 138 may be a single-stage, belt-driven compressor operably coupled to the belt module 140, although other suitable compressor modules (e.g., direct-drive compressors or multi-stage compressors) are contemplated. The belt module 140 is designed to operatively couple the compressor module 138 to the dual-fuel engine subassembly 126. The belt module 140 includes a belt housing 142 and a belt 144 (see FIG. 2). The belt housing 142 may be provided in the form of a three-dimensional hollow body (e.g., a rectangular prism) designed to surround the belt 144 to preferably prevent foreign objects from coming into contact with the belt 144.

Referring still to FIG. 1, the system control panel 106 may be disposed on the platform 116 proximate to the dual-fuel engine subassembly 126 and on an opposing side of the trailer 102 from the compressor subassembly 128, although other possible locations for the system control panel 106 would be consistent with the teachings provided herein. The system control panel 106 includes one or more control panel legs 146 that support a main panel 148. The control panel legs 146 may be rectilinear members, and the main panel 148 may be provided in the form of a rectangular housing with one or more indicators 150, controls 152, and a greenhouse gas (“GHG”) emissions savings display unit 154 (hereinafter, the “GHG display unit 154”) disposed thereon. The indicators 150 and the controls 152 are designed for monitoring and controlling the operation of the compressor system 100. For example, the indicators 150 may be provided in the form of dial-type indicators and/or digital displays which indicate system parameters such as the RPM of the engine, the temperature of the natural gas, or the pressure within the suction bottle 112 or the fuel bottle 114. The controls 152 may be provided in the form of key-turns, switches, and/or levers that control the operation of the dual-fuel engine subassembly 126, the compressor subassembly 128, and/or the aftercooler 110.

The propane tank 108 may be disposed behind or proximate to the system control panel 106 and may be provided in the form of a cylindrical pressure vessel, although other locations and shapes for the propane tank 108 would be consistent with the teachings herein. For example, the propane tank 108 may be a commercially available, standard-size, refillable propane tank (e.g., a 20 lb. propane tank).

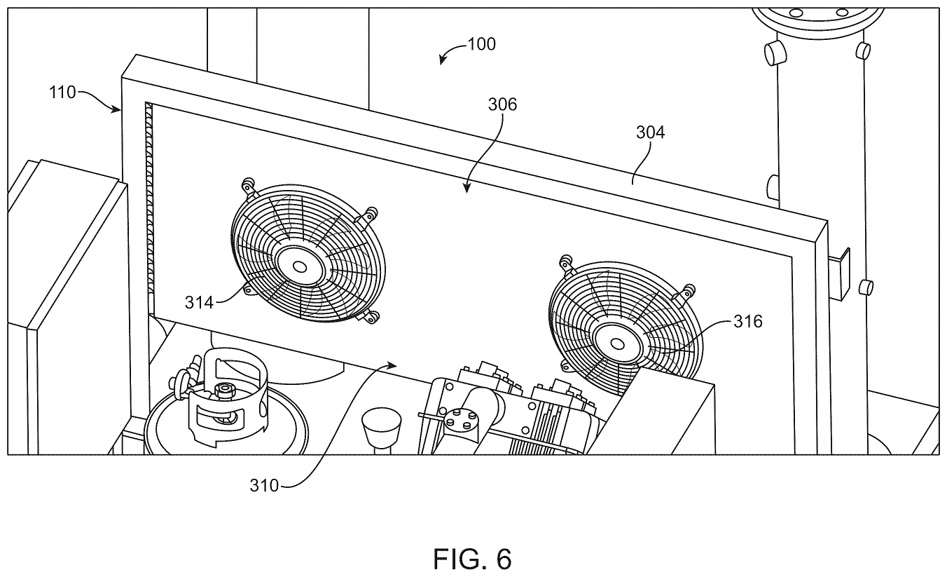

The aftercooler 110 may be disposed behind the propane tank 108 and the compressor subassembly 128. As will be described in greater detail in connection to FIGS. 6-8, the aftercooler 110 may be designed to reduce the temperature of natural gas before the natural gas is injected into a utility pipe or received in the fuel bottle 114.

Referring still to FIG. 1, the suction bottle 112 and the fuel bottle 114 may be disposed on opposing sides of a rear portion 156 of the trailer 102, although other locations for the suction bottle 112 and fuel bottle 114 would be consistent with the teachings herein. For example, the suction bottle 112 may be disposed behind the propane tank 108 and the aftercooler 110, and the fuel bottle 114 may be disposed behind the compressor subassembly 128 and the aftercooler 110. The suction bottle 112 and the fuel bottle 114 may each be provided in the form of a pressure vessel that is substantially cylindrical. The suction bottle 112 may additionally include a support structure portion 158 which interfaces with the platform 116 of the trailer 102. The support structure portion 158 may be provided in the form of a tubular body (e.g., a “skirt” support structure); however, other configurations for the support structure portion 158 (e.g., support legs) are contemplated. In alternative embodiments, the fuel bottle 114 may also include a support structure portion.

Referring to FIG. 2, the compressor system 100 is depicted with the engine housing 134 and the belt housing 142 removed to illustrate the compressor module 138, the belt 144, and the engine module 130 in greater detail. The compressor module 138 is disposed proximate to the dual-fuel engine subassembly 126 (i.e., towards the rear portion 156 of the trailer 102 from the dual-fuel engine subassembly 126) and is adapted to receive input power via an input pulley 180 to compress gaseous fluids as known in the art. The belt 144 may be provided in the form of an elastic member shaped in a closed loop that circumscribes the input pulley 180 and the output pulley 182. Thus, the belt 144 is designed to transfer power from the engine module 130 to the compressor module 138.

The engine module 130 is designed to generate rotational power at an output pulley 182 using one of a plurality of fuel sources (e.g., gasoline, diesel, natural gas, propane, etc.). The rotational power may then be harnessed by the compressor system 100 to, for example, evacuate natural gas from a pipeline, inject natural gas into a pipeline, and/or power various electronic components of the compressor system 100. In one embodiment, the engine module 130 may be provided in the form of an internal combustion engine adapted to operate using a first fuel source in a first operational mode and a second fuel source in a second operational mode. In such embodiments, the first fuel source and the second fuel source may be selected from the group consisting of gasoline, diesel, ethanol, natural gas, propane, and combinations thereof. In other embodiments, the engine module 130 may be provided in the form of an internal combustion engine designed to operate using propane (e.g., from the propane tank 108) in a first operational mode and natural gas (e.g., from the fuel bottle 114) in a second operational mode.

In some embodiments, the engine module 130 may include a third operational mode wherein the engine module 130 is designed to operate using a mix of fuel sources, such as a combination of propane (e.g., from the propane tank 108) and natural gas (e.g., from the fuel bottle 114). Further, the engine module 130 may include a fourth operational mode wherein neither propane nor natural gas are used by the engine module 130 (i.e., when the engine module 130 is in a shutdown state).

In some embodiments, the operational mode of the engine module 130 may be selected automatically by a controller (not illustrated), and the engine module 130 may be automatically controlled to operate in the selected operational mode. In such embodiments, the controller may monitor various parameters of the compressor system 100 (including, by way of example, the amount of the first fuel source available, the amount of the second fuel source available, the necessary operational output of the engine module 130, or fuel-efficiency considerations). The controller may use the various parameters as inputs to determine which of the operational modes to select. For example, the controller may select the fourth operational mode if the necessary power output value of the engine module 130 is about zero. As an additional example, the second operational mode may be selected if the source of propane (e.g., the propane tank 108) is substantially depleted. Once one of the operational modes has been selected, the controller may communicate with solenoids to control the flow of propane and natural gas to the engine module 130. Thus, the controller may select and control the operational mode of the engine module 130.

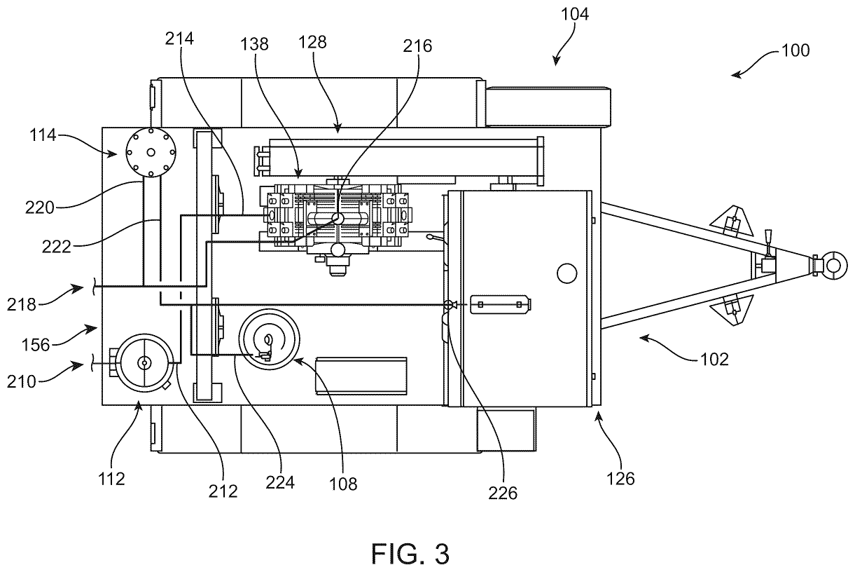

As best illustrated in FIG. 3, the compressor system 100 may further include a system inlet 210, a suction bottle outlet 212, a compressor inlet 214, a compressor outlet 216, a system outlet 218, a fuel bottle inlet 220, a fuel bottle outlet 222, a propane tank outlet 224, and an engine inlet 226. The system inlet 210 may be coupled to the suction bottle 112, and the suction bottle outlet 212 may be provided on the suction bottle 112. The compressor inlet 214 and the compressor outlet 216 may be provided on the compressor module 138, and the system outlet 218 may be coupled to the compressor outlet 216. Furthermore, the fuel bottle inlet 220 and the fuel bottle outlet 222 may be provided on the fuel bottle 114, and the propane tank outlet 224 and the engine inlet 226 may be provided on the propane tank 108 and the dual-fuel engine subassembly 126, respectively.

The system inlet 210 may be disposed on the rear portion 156 of the trailer 102 and may be adapted to couple to a utility pipe during maintenance activities to place the utility pipe and the compressor system 100 in fluid communication. The system inlet 210 may be in fluid communication with the suction bottle 112 such that the suction bottle 112 may receive natural gas from a utility pipe via the system inlet 210. The natural gas received in the suction bottle 112 may be selectively released from the suction bottle 112 via the suction bottle outlet 212. For example, the suction bottle outlet 212 may include a valve for selectively releasing natural gas from the suction bottle 112.

The compressor inlet 214 may be fluidly coupled to the suction bottle outlet 212 so that the compressor subassembly 128 may receive natural gas from the suction bottle 112. During operation of the compressor module 138, the natural gas received at the compressor inlet 214 may be at a first pressure and the natural gas may be compressed to a second, higher pressure before being provided to the compressor outlet 216. Moreover, the compressor outlet 216 may be fluidly coupled with the system outlet 218 positioned on or proximate to the rear portion 156 of the trailer 102 and adapted to couple to the utility pipe (although other possible locations for the system outlet 218 would be appreciated by those having skill in the art). Thus, the compressor subassembly 128 may preferably inject natural gas into a utility pipe via the system outlet 218.

In some embodiments, the system inlet 210 may couple to a first utility pipe and the system outlet 218 may couple to a second utility pipe. In such embodiments, the compressor system 100 may evacuate natural gas from the first utility pipe and reinject the natural gas into the second utility pipe. In other embodiments, a utility pipe may include a first segment and a second segment, and the system inlet 210 may couple to the first segment of the utility pipe and the system outlet 218 may couple to the second segment of the utility pipe.

The fuel bottle inlet 220 may also be fluidly coupled to the compressor outlet 216. Thus, the fuel bottle 114 may receive natural gas from the compressor subassembly 128 via the fuel bottle inlet 220, and the fuel bottle 114 may store the natural gas therein. The natural gas stored in the fuel bottle 114 may be selectively released from the fuel bottle 114 at the fuel bottle outlet 222.

The fuel bottle outlet 222 and the propane tank outlet 224 may be fluidly coupled to the engine inlet 226 provided on the engine module 130 (see FIG. 2) of the dual-fuel engine subassembly 126. The fuel bottle outlet 222 and the propane tank outlet 224 are designed to selectively provide natural gas or propane, respectively, to the dual-fuel engine subassembly 126. As a result, the engine module 130 may operate on natural gas from the fuel bottle 114 in a first operational mode and propane from the propane tank 108 in a second operational mode. For example, when the fuel bottle 114 and the propane tank 108 are adequately filled with propane or natural gas, an operator may selectively configure the dual-fuel engine subassembly 126 to run on either natural gas or propane. However, during the initial operation of the compressor system 100, when the fuel bottle 114 is being filled with natural gas from a utility pipe, the operator may selectively configure the dual-fuel engine subassembly 126 to operate using propane.

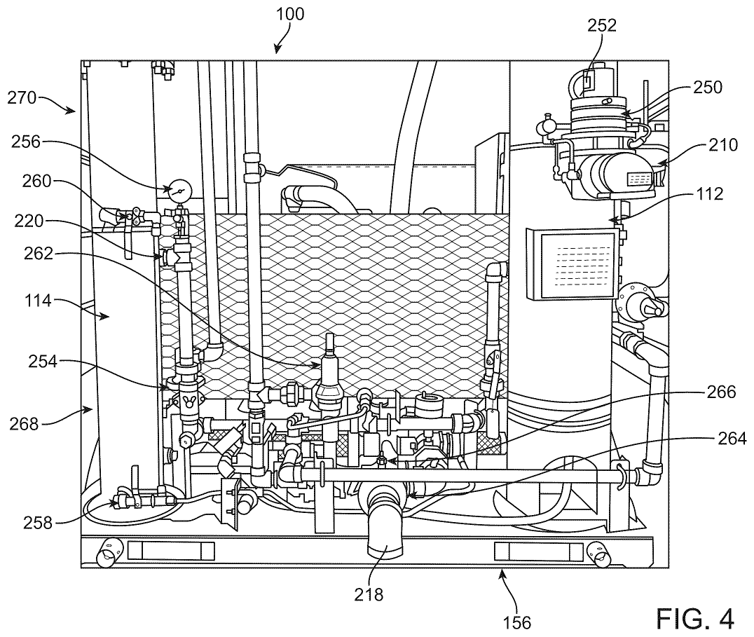

Referring to FIG. 4, the compressor system 100 may further include a suction bottle pressure regulator 250, a suction bottle pressure gauge 252, a fuel bottle pressure regulator 254, a fuel bottle pressure gauge 256, a lower fuel bottle drain 258, an upper fuel bottle drain 260, a system pressure relief valve 262, an outlet check valve 264, and an outlet temperature sensor 266. Together, these components may be utilized to (1) control the storage or flow of natural gas in the compressor system 100 and/or (2) monitor and/or control the physical characteristics (e.g., temperature or pressure) of the natural gas throughout the compressor system 100.

The suction bottle pressure regulator 250 may be positioned and located on the system inlet 210, or otherwise fluidly coupled to the system inlet 210, to regulate the pressure of the natural gas entering the suction bottle 112. The suction bottle pressure regulator 250 may help ensure that the natural gas entering the suction bottle 112 from the utility pipe does not exceed a first threshold pressure value. In some embodiments, the first threshold pressure value may be less than a maximum rated pressure value of the suction bottle 112. In other embodiments, the first threshold pressure value may be less than a conventionally accepted safety limit.

To help verify the suction bottle pressure regulator 250 is functioning and that the pressure in the suction bottle 112 does not exceed the first threshold pressure, the suction bottle pressure gauge 252 may be configured to display the pressure in the suction bottle 112. The suction bottle pressure gauge 252 may be a dial-type indicator, although in other embodiments a digital indicator or transmitter may be provided. In addition to verifying that the first threshold pressure is not exceeded, the pressure reading from the suction bottle pressure gauge 252 may also be utilized to monitor the amount of natural gas stored in the suction bottle 112.

Referring still to FIG. 4, the fuel bottle pressure regulator 254 may be positioned on or proximate to the fuel bottle 114 and in fluid communication with the fuel bottle inlet 220. The fuel bottle pressure regulator 254 may be adapted to reduce the pressure of the natural gas from the compressor subassembly 128 (see FIGS. 1 and 3) before the natural gas enters the fuel bottle 114. For example, the fuel bottle pressure regulator 254 may be adapted to reduce the pressure of the natural gas to a value at or below a second threshold pressure. The second threshold pressure may be less than the maximum rated pressure of the fuel bottle 114, or the second threshold pressure may be less than a conventionally accepted safety limit.

To verify the fuel bottle pressure regulator 254 is functioning and the pressure in the fuel bottle 114 does not exceed the second threshold pressure, the fuel bottle 114 may further include a fuel bottle pressure gauge 256 designed to display the pressure in the fuel bottle 114. The fuel bottle pressure gauge 256 may be a dial-type indicator, although in other embodiments a digital indicator or transmitter may be provided. In addition to verifying that the second threshold pressure is not exceeded, the pressure reading from the fuel bottle pressure gauge 256 may also be utilized to monitor the amount of natural gas stored in the fuel bottle 114.

The lower fuel bottle drain 258 and the upper fuel bottle drain 260 may be provided in the form of ball valves coupled to discharge pipes routed away from the fuel bottle 114. The lower fuel bottle drain 258 may be positioned on or proximate to a lower portion 268 of the fuel bottle 114 and may be designed to selectively release natural gas, water, and condensed natural gas vapors from the fuel bottle 114. The upper fuel bottle drain 260 may be positioned on or proximate to an upper portion 270 of the fuel bottle 114 and may be adapted to selectively release natural gas from the fuel bottle 114.

The system pressure relief valve 262 may be fluidly coupled to the compressor subassembly 128 and the system outlet 218. The system pressure relief valve 262 may be designed to release natural gas when the pressure of the natural gas exceeds a third threshold pressure value. The release of natural gas from the system pressure relief valve 262 may preferably lower the pressure of the natural gas in the compressor system 100. Thus, the system pressure relief valve 262 may preferably maintain the natural gas at or below a third threshold pressure. The third threshold pressure may be less than a maximum rated pressure of the compressor system 100, and thus, the system pressure relief valve 262 may be designed to maintain the compressor system 100 within safe pressure ranges.

In some embodiments, the first, second, and third threshold pressure values described herein may be the same value. In other embodiments, any of the first, second, and third threshold pressure values may be different from the other threshold pressure values.

Referring still to FIG. 4, the outlet check valve 264 may be positioned and located in the fluid flow path on, or proximate to, the system outlet 218 to prevent backflow of natural gas through the system outlet 218. The outlet check valve 264 may be adapted to ensure that natural gas from the utility pipe preferably does not flow into the system outlet 218.

The outlet temperature sensor 266 may be designed to monitor the temperature of the natural gas injected into the pipes. The outlet temperature sensor 266 may be provided in the form of a digital transmitter in fluid communication with the system outlet 218. In other embodiments, the outlet temperature sensor 266 may be a dial-type indicator or a digital indicator. The outlet temperature sensor 266 may be in communication with a controller to automatically disable the operation of the engine module 130 (see FIG. 2) when the temperature of the natural gas exceeds a maximum temperature threshold (e.g., 140° F.). In yet other embodiments, the outlet temperature sensor 266 and the controller may automatically disable the operation of the compressor system 100 and/or sound an audible alarm if the temperature of the natural gas exceeds the maximum temperature threshold.

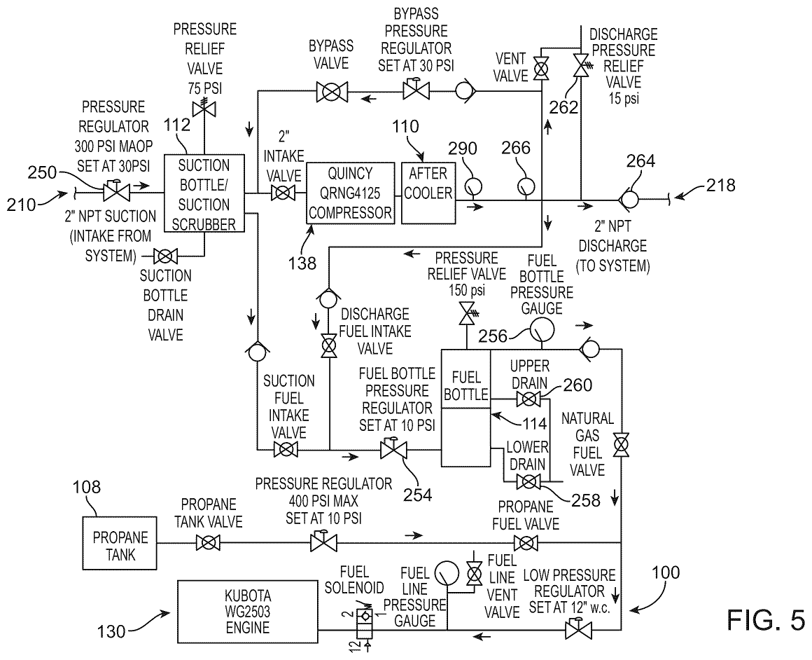

Referring to FIG. 5, a schematic diagram for the compressor system 100 is illustrated. Components that are similarly numbered in FIG. 5 as the components provided in FIGS. 1-4 may have substantially the same structure and function as those components previously described herein.

As illustrated in FIG. 5, the aftercooler 110 may be fluidly coupled to the compressor module 138 and the system outlet 218, and an aftercooler thermostat 290 may be fluidly coupled to the aftercooler 110 and the system outlet 218. As will be described in greater detail below, the aftercooler 110 is adapted to lower the temperature of the natural gas flowing to the system outlet 218 and the fuel bottle 114. The aftercooler thermostat 290 (in conjunction with or independently of an associated controller) is designed to control the operation of the aftercooler 110 based on the temperature of the natural gas flowing from the aftercooler 110 to the system outlet 218. The aftercooler thermostat 290 may be provided in the form of a thermocouple with a direct reading gauge and digital outputs. When the temperature of the natural gas is at and/or below a first threshold temperature, the aftercooler thermostat 290 may disable operation of the aftercooler 110. When the temperature is at and/or above a second threshold temperature (e.g., 100° F.), the aftercooler thermostat 290 may enable operation of the aftercooler 110. The first threshold temperature may be less than the second threshold temperature, or the first threshold temperature may be the same temperature as the second threshold temperature. In some embodiments, the aftercooler thermostat 290 (in conjunction with or independently of an associated controller) may further control the aftercooler 110 such that the aftercooler 110 may operate at a variable capacity at least partially dependent on the temperature of the natural gas. For example, the aftercooler thermostat 290 may control the aftercooler 110 to facilitate a rate of heat transfer proportional to the difference between the second threshold temperature and the temperature of the natural gas.

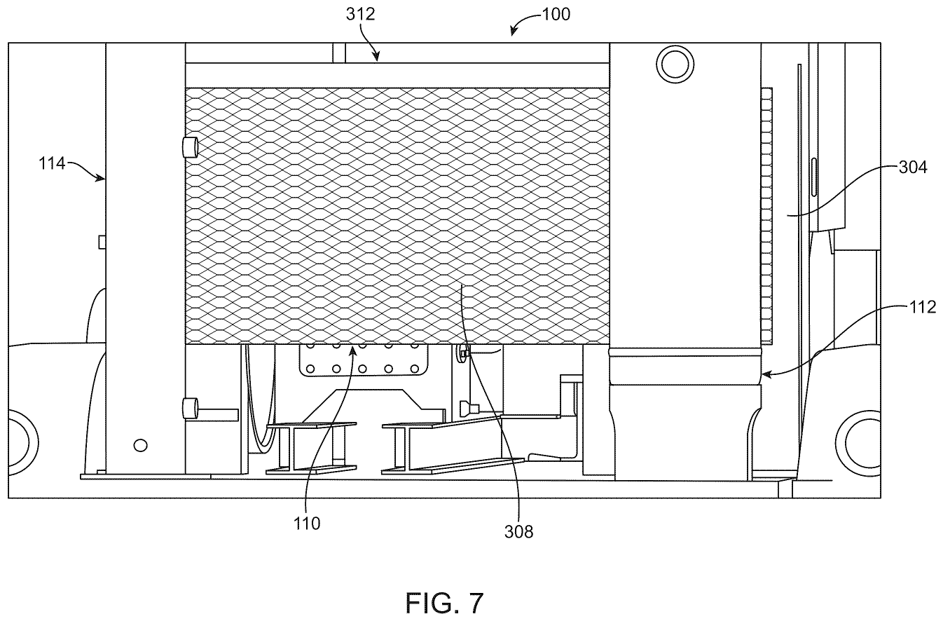

Referring to FIGS. 6 and 7, the aftercooler 110 is provided in the form of an aftercooler housing 304, a fan arrangement 306 (see FIG. 6), and a heat exchanger 308 (see FIG. 7). As described herein, the aftercooler 110 is designed to preferably lower the temperature of natural gas flowing from the compressor subassembly 128 (see FIGS. 1 and 3) to the system outlet 218 (see FIGS. 3-5) from an inlet temperature to an outlet temperature. In some embodiments, the outlet temperature may be equal to or less than the maximum temperature threshold described in connection to FIG. 4, or the first or second threshold temperatures described in connection to FIG. 5.

The aftercooler housing 304 may be provided in the form of a three-dimensional hollow body (e.g., a rectangular prism) that spans across the platform 116. The fan arrangement 306 and the heat exchanger 308 may be disposed on a front side 310 (see FIG. 6) and a rear side 312 (see FIG. 7) of the aftercooler housing 304, respectively. In alternative embodiments, the fan arrangement 306 and the heat exchanger 308 may otherwise be positioned on the aftercooler housing 304 or the trailer 102.

Referring still to FIGS. 6 and 7, the aftercooler 110 may be a forced-draft air-to-fluid heat exchanger, although alternative types of heat exchangers may be used with the compressor system 100. The fan arrangement 306 may be provided in the form of a first fan 314 and a second fan 316 disposed on opposing sides of the aftercooler 110, although other quantities or positions of fans are contemplated. The fan arrangement 306 may be designed to induce a flow of air across the heat exchanger 308 (e.g., by operating the first and second fans 314, 316, respectively). The heat exchanger 308 is designed to facilitate heat transfer between the airflow induced by the fan arrangement 306 and a fluid (e.g., natural gas) as the fluid flows through the heat exchanger 308. Although not specifically depicted herein, the heat exchanger 308 may be provided in the form of a tubular member shaped in a serpentine fashion with heat sink fins protruding therefrom.

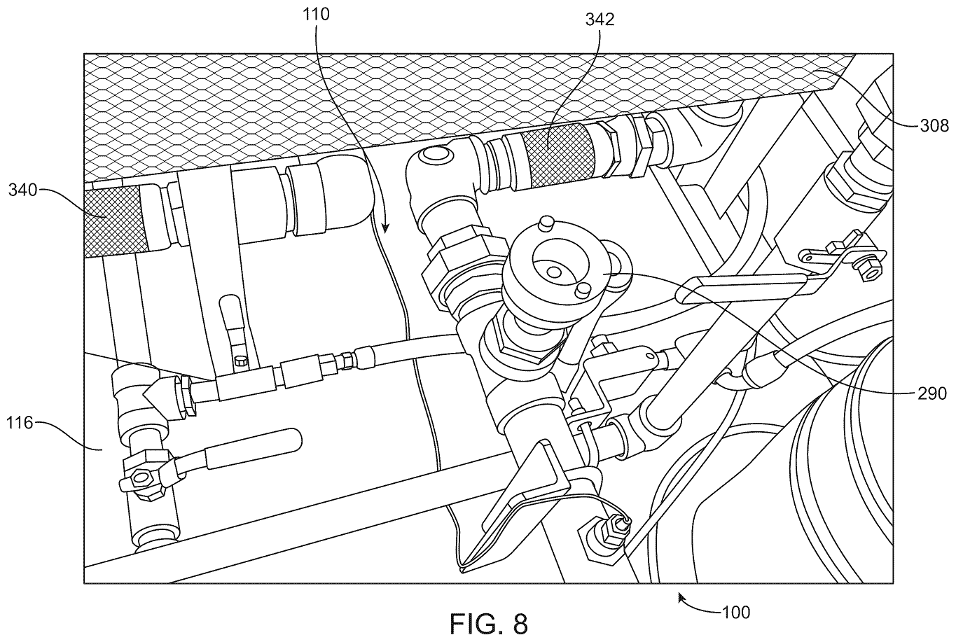

Turning to FIG. 8, the heat exchanger 308 (see FIG. 7) may be coupled to an aftercooler inlet 340 and an aftercooler outlet 342. The aftercooler inlet 340 may be in fluid communication with the compressor outlet 216 (see FIG. 3). As a result, the aftercooler 110 may receive natural gas from the compressor subassembly 128 (see FIGS. 1 and 3) at an inlet temperature. The natural gas received from the compressor subassembly 128 may travel through the heat exchanger 308 and may exit the aftercooler 110 via the aftercooler outlet 342. The aftercooler outlet 342 may be in fluid communication with the system outlet 218 (see FIGS. 3-5). As a result, natural gas may flow from the compressor subassembly 128 through the aftercooler 110 to the system outlet 218. As the natural gas travels through the aftercooler 110, the fan arrangement 306 (see FIG. 6) may induce a flow of air across the heat exchanger 308 to facilitate heat transfer between the natural gas and the ambient environment. Accordingly, the aftercooler 110 may lower the temperature of natural gas as the natural gas flows from the aftercooler inlet 340 to the aftercooler outlet 342. As a result, when the aftercooler 110 operates, the outlet temperature of the natural gas at the aftercooler outlet 342 is preferably less than the inlet temperature of the natural gas at the aftercooler inlet 340.

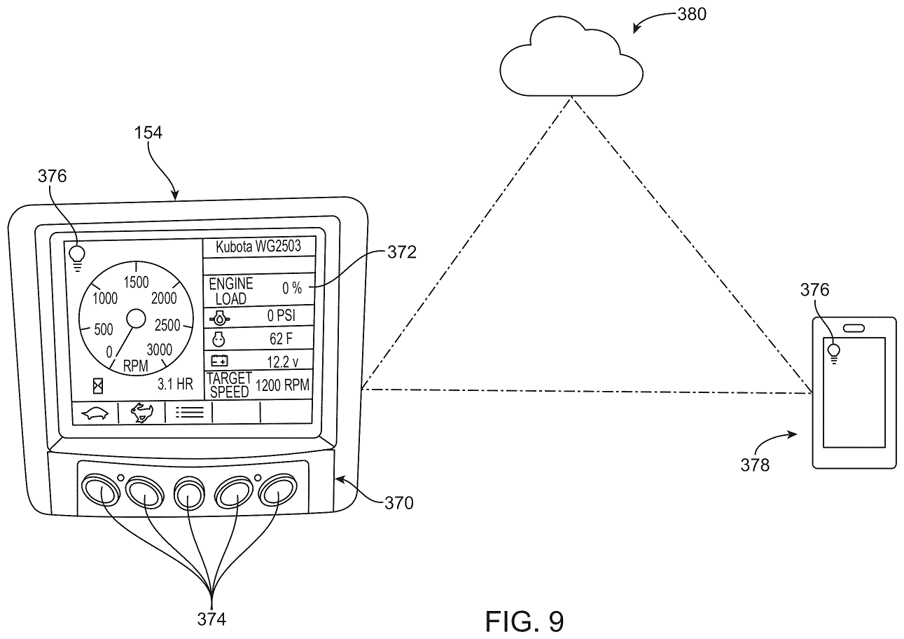

As illustrated in FIG. 9, the GHG display unit 154 may be provided in the form of a housing 370, a display 372 mounted on the housing 370, one or more user inputs 374 mounted on the housing 370, and a controller in communication with the display 372 and the one or more user inputs 374. The housing 370 may be retained in the main panel 148 (see FIG. 1) and may be substantially rectangular (although the housing 370 may be provided in other shapes and/or provided elsewhere on the compressor system 100). The display 372 is designed to relay one or more outputs 376 from the controller to a user. The one or more user inputs 374 may be provided in the form of push buttons adapted to provide user commands to the controller, although other types of input systems may also be used or provided with the GHG display unit 154.

The controller may be provided in the form of a memory and a processor, and the controller may be in communication with a mobile device 378 and a network 380 in a wired manner (e.g., via an ethernet cable, a USB cable, and/or an analog cable) or a wireless manner (e.g., Wi-Fi, Bluetooth, and/or NFC). The memory may include software and data and is designed for the storage and retrieval of processed information to be processed by the processor. The processor is configured to process signals (e.g., from a measurement device such as a flow rate sensor or a pressure sensor) and to provide outputs 376 based on the processed signals. The controller may operate autonomously or semi-autonomously, may read executable software instructions from the memory or a computer-readable medium (e.g., a hard drive, a CD-ROM, flash memory), and/or may receive commands from another source logically connected to the processor. For example, the processor may receive commands from one or more of the user inputs 374, the mobile device 378, or a computer or server connected over the network 380.

In some embodiments, the output 376 from the processor may be a volume of natural gas that the compressor system 100 has evacuated from pipes and/or injected into the pipes. For example, the controller may receive signals from a measurement device, such as a flow rate sensor (not illustrated) disposed in the fluid flow path of the system inlet 210 (see FIGS. 3-5) or in the fluid flow path of the system outlet 218 (see FIGS. 3-5). The controller may store the signals in the memory, and the processor may process the signals to calculate the volume of the natural gas as the output 376. The volume of natural gas may be calculated as a cumulative total over the lifetime of the compressor system 100 and/or over a given time period (e.g., past day, past 7 days, past 30 days, etc.) as selected via the user inputs 374. In alternative embodiments, the processor may calculate the mass of natural gas that the compressor system 100 has evacuated from pipes and/or injected into the pipes. In some aspects, the controller processes the volume of the natural gas in real-time or substantially real-time.

In some embodiments, one of the outputs 376 from the processor may be the volume and/or mass of greenhouse gases (e.g., methane and/or carbon dioxide) in the natural gas. In other embodiments, the processor may calculate an environmental impact value and provide the environmental impact value as an output 376. The environmental impact value may equate the volume of natural gas to greenhouse gas producing activities or greenhouse gas removing activities. For example, the processor may execute the software to estimate a number of trees planted or a number of miles driven in a vehicle that is equivalent (from a volume of greenhouse gas perspective) to the volume of natural gas evacuated from or injected into the pipe.

The outputs 376 generated by the processor may be displayed in real time on the display 372, mobile device 378, or another device logically connected to the GHG display unit 154 via the network 380. The user inputs 374, mobile device 378, or network 380 may also send commands to the processor to select the outputs 376, select the format of the outputs 376 (e.g., the units of measurement associated with outputs 376), and/or generate reports related to the outputs 376. For example, the GHG display unit 154 may generate reports with the outputs 376, historical statistics, trends, and data analytics. The reports may then be displayed on the display 372, mobile device 378, or another device connected via the network 380. In further embodiments, the reports generated by the GHG display unit 154 may include outputs 376, statistics, trends, and data analytics for a plurality of compressor systems 100 connected via the network 380.

It will be appreciated by those skilled in the art that while the above disclosure has been described above in connection with particular embodiments and examples, the above disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the above disclosure are set forth in the following claims.

1. A compressor system comprising:
a system inlet adapted to couple with a utility pipe;
a compressor in fluid communication with the system inlet to receive a first fluid from the utility pipe;
a first fuel bottle in fluid communication with the compressor to receive the first fluid from the compressor;
a second fuel bottle adapted to receive a second fluid that is different than the first fluid; and
a dual-fuel engine coupled with the compressor to provide input power to the compressor, the dual-fuel engine is coupled with the first fuel bottle and the second fuel bottle, wherein the dual-fuel engine is adapted to operate using the first fluid in a first operational mode and the second fluid in a second operational mode.

2. The compressor system of claim 1, wherein the first fluid is provided in a form of natural gas and the second fluid is provided in the form of propane.

3. The compressor system of claim 1, further comprising:
a controller in electrical communication with the dual-fuel engine, the controller adapted to select an operational mode of the dual-fuel engine based on an availability of the first fluid and the second fluid.

4. The compressor system of claim 1, wherein the compressor is provided in a form of a single-stage, belt-driven compressor operably coupled to the dual-fuel engine.

5. The compressor system of claim 1, further comprising:
an aftercooler in fluid communication with the compressor, the aftercooler adapted to lower the temperature of the first fluid before the first fluid is received in the first fuel bottle.

6. The compressor system of claim 1, further comprising:
a display unit in electrical communication with a controller, the display unit is adapted to provide real-time data on a volume of natural gas evacuated and injected, and to generate reports on greenhouse gas emissions savings based on the real-time data.

7. The compressor system of claim 1, wherein the system inlet is adapted to couple with a first utility pipe and the system outlet is adapted to couple with a second utility pipe, the compressor system adapted to evacuate the first fluid from the first utility pipe and inject the first fluid into the second utility pipe.

8. A compressor system comprising:
a suction bottle designed to receive a fluid from a first utility pipe;
a compressor in fluid communication with the suction bottle designed to receive the fluid from the suction bottle and inject the fluid into a second utility pipe; and
a controller in electrical communication with a sensor, the sensor designed to monitor a volume of the fluid received from or injected into a utility pipe and to send an input to the controller related to the volume of the fluid received and injected, wherein the controller generates an output based on the input received from the sensor.

9. The compressor system of claim 8, wherein the output comprises a report containing a volume of prevented greenhouse gas emissions calculated from the volume of the fluid received and injected.

10. The compressor system of claim 8, wherein the controller is in electrical communication with the dual-fuel engine, the controller adapted to select an operational mode of the dual-fuel engine based on an availability of the first fluid and the second fluid.

11. The compressor system of claim 8, wherein the compressor is a single-stage, belt-driven compressor operably coupled to the dual-fuel engine.

12. The compressor system of claim 8, further comprising:
an aftercooler in fluid communication with the compressor, the aftercooler adapted to lower a temperature of the first fluid before the first fluid is received in a first fuel bottle.

13. The compressor system of claim 8, further comprising:
a suction bottle pressure regulator positioned on a system inlet to regulate a pressure of the fluid entering the suction bottle below a first threshold pressure value.

14. The compressor system of claim 13, wherein the system inlet is adapted to couple with the first utility pipe and a system outlet is adapted to couple with the second utility pipe, the compressor system adapted to evacuate the first fluid from the first utility pipe and inject the first fluid into the second utility pipe.

15. A compressor system comprising:
a system inlet adapted to couple with a utility pipe;
a compressor in fluid communication with the system inlet to receive a first fluid from the utility pipe;
a first fuel bottle in fluid communication with the compressor to receive the first fluid from the compressor;
a second fuel bottle adapted to receive a second fluid that is different than the first fluid;
a dual-fuel engine coupled with the compressor to provide input power to the compressor, the dual-fuel engine coupled with the first fuel bottle and the second fuel bottle; and
an aftercooler in fluid communication with the compressor, the aftercooler adapted to lower a temperature of the first fluid before the first fluid is received in the first fuel bottle.

16. The compressor system of claim 15, wherein the dual-fuel engine is adapted to operate using the first fluid in a first operational mode and the second fluid in a second operational mode.

17. The compressor system of claim 16, further comprising:
a controller in electrical communication with the dual-fuel engine, the controller adapted to automatically select an operational mode of the dual-fuel engine based on an availability of the first fluid and the second fluid.

18. The compressor system of claim 15, further comprising:
a suction bottle designed to receive the first fluid from a first segment of the utility pipe;
the compressor in fluid communication with the suction bottle, wherein the compressor is designed to receive the fluid from the suction bottle; and
the aftercooler is designed to reduce a temperature of the fluid before the compressor injects the first fluid into a second segment of the utility pipe.

19. The compressor system of claim 18, further comprising:
a controller in electrical communication with a sensor, the sensor designed to monitor a volume of the first fluid received from the first segment of the utility pipe and injected into the second segment of the utility pipe and to send an input to the controller related to the volume, wherein the controller generates an output based on the input received from the sensor.

20. The compressor system of claim 19, further comprising:
a display unit in electrical communication with the controller, the display unit is adapted to provide real-time data on the volume of the first fluid received from the first segment of the utility pipe and injected into the second segment of the utility pipe, and to generate reports on greenhouse gas emissions savings based on the real-time data.
